(19) United States
(12) Patent Application Publication
(10) Pub. No.: US 2009/0197180 A1
(43) Pub. Date: Aug. 6, 2009

(54) SPACERS BETWEEN TABS OF ELECTRODE PLATES IN AN ELECTROCHEMICAL CELL FOR AN IMPLANTABLE MEDICAL DEVICE

(76) Inventors: Joseph J. Viavattine, Vadnais Heights, MN (US); Kevin R. Aufderhar, Coon Rapids, MN (US); Paul B. Aamodt, Minnetonka, MN (US); Hailiang Zhao, Maple Grove, MN (US)

Correspondence Address: MEDTRONIC, INC., 710 MEDTRONIC PARKWAY NE, MINNEAPOLIS, MN, 55432-9924, US

(21) Appl. No.: 12/024,086

(22) Filed: Jan. 31, 2008

(51) Int. Cl. H01M 2/14

(52) U.S. Cl. 429/246; 429/247

(57) ABSTRACT

A battery (or cell) in an implantable medical device is presented. The cell includes a first electrode element with a first tab extending therefrom and a second electrode element with a second tab extending therefrom. A spacer is coupled to the first and second tabs.

### CROSS-REFERENCE TO RELATED APPLICATION

The present application claims priority and other benefits from U.S. application Ser. No. 11/701,329 filed Jan. 31, 2007, and requested to be converted to a provisional application on Jan. 30, 2008, the disclosure of which is incorporated herein by reference in its entirety.

### FIELD OF THE INVENTION

The present invention generally relates to an electrochemical cell for an implantable medical device, and, more particularly, to a spacer located between a first and second tabs for electrode plates in the electrochemical cell.

### BACKGROUND OF THE INVENTION

Implantable medical devices (IMDs) such as implantable pulse generators (IPGs) or implantable cardioverter-defibrillators (ICDs) comprise, inter alia, a control module, a capacitor, and a battery that are housed in a hermetically sealed container. The battery includes a case, a liner, an electrode assembly, and electrolyte. The liner insulates the electrode assembly from the case. The electrode assembly includes electrodes, an anode and a cathode, with a separator therebetween.

For a flat plate battery, an electrode (i.e. an anode, a cathode) comprises a set of electrode plates with a set of tabs extending therefrom that are electrically connected. During the process of connecting the tabs, a tab may become bent or cut, which may result in the assembly being scrapped. It is therefore desirable to overcome bending or cutting of the tabs during the assembly process in order to reduce manufacturing costs.

### BRIEF DESCRIPTION OF THE DRAWINGS

The present invention will become more fully understood from the detailed description and the accompanying drawings, wherein:

FIG. 1 is a cutaway perspective view of an implantable medical device (IMD);

FIG. 2 is a cutaway perspective view of a battery (or cell) in the IMD of FIG. 1;

FIG. 3A is an enlarged view of a portion of an electrode assembly depicted in FIG. 2;

FIG. 3B is a cross-sectional view of a portion of an electrode assembly depicted in FIG. 2;

FIG. 3C is an enlarged view of a portion of an electrode assembly with an H-shaped spacer in a battery;

FIG. 4A is an angled cross-sectional view of a current collector in an electrode plate of the electrode assembly depicted in FIG. 3A;

FIG. 4B is an angled cross-sectional view of the electrode plate that includes the current collector depicted in FIG. 4A along with electrode material disposed thereon;

FIG. 5 is a top view of a current collector;

FIG. 6A is a top view of a H-shaped spacer;

FIG. 6B is an angled view of a H-shaped spacer;

FIG. 7A is a top view of a double T-shaped spacer;

FIG. 7B is an angled view of a double T-shaped spacer;

FIG. 8 is an enlarged view of a portion of an electrode assembly with rectangular spacers in a battery in which spacers and tabs are welded together;

FIG. 9 is an angled view of a rectangular spacer;

FIG. 10A is a perspective view of stacked electrode plates with a spacer between each tab; and

FIG. 10B is an angled perspective view of stacked electrode plates with a spacer between each tab.

### DETAILED DESCRIPTION

The following description of embodiments is merely exemplary in nature and is in no way intended to limit the invention, its application, or uses. For purposes of clarity, the same reference numbers are used in the drawings to identify similar elements.

The present invention is directed to an electrochemical cell such as a battery in an implantable medical device (IMD). The battery includes an electrode assembly that comprises a set of electrode plates. Each electrode plate includes a current collector with a tab extending therefrom and electrode material (also referred to as active material) disposed over the current collector. A spacer is placed between a first and a second tab that extend from a first and a second electrode plate, respectively. Each spacer ensures tabs are not bent when a set of tabs are connected during a subassembly process, which improves the quality of the tab connection process while reducing the cost to produce an electrode assembly.

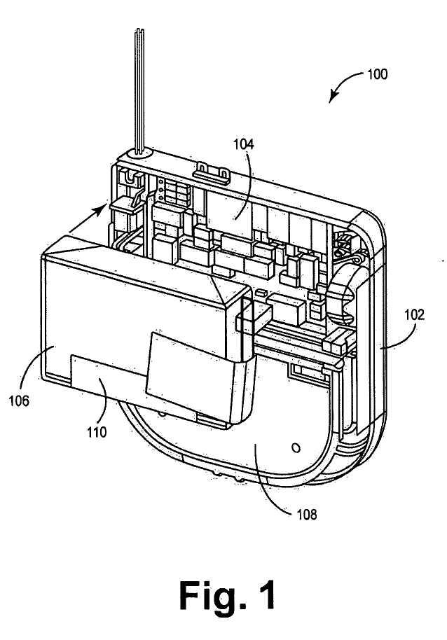

FIG. 1 depicts an IMD 100 (e.g. implantable cardioverter-defibrillators (ICDs) etc.). IMD 100 includes a case 102, a control module 104, a battery 106 (e.g. organic electrolyte battery etc.) and capacitor(s) 108. Control module 104 controls one or more sensing and/or stimulation processes from IMD 100 via leads (not shown). Battery 106 includes an insulator 110 (or liner) disposed therearound. Battery 106 charges capacitor(s) 108 and powers control module 104.

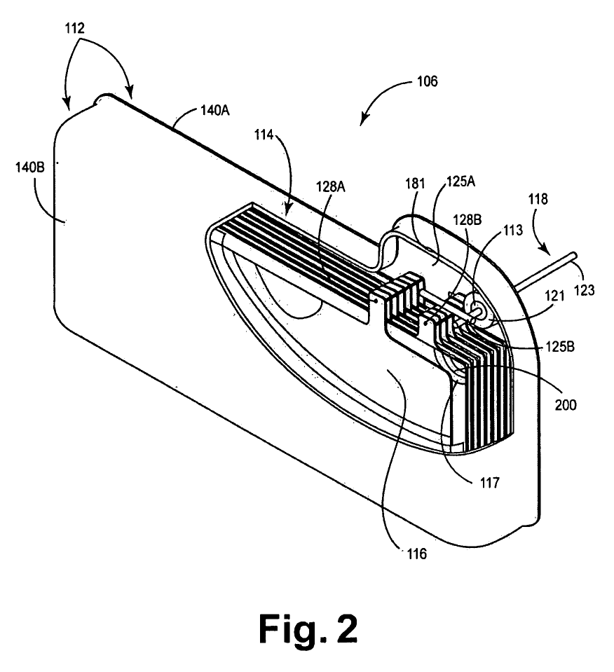

FIGS. 2 through 5 depict details of an exemplary organic electrolyte battery 106. Battery 106 includes an encasement 112, a feed-through terminal 118, a fill port 181 (partially shown), a liquid electrolyte 116, and an electrode assembly 114. Encasement 112, formed by a cover 140A and a case 140B, houses electrode assembly 114 with electrolyte 116. Feed-through assembly 118, formed by pin 123, insulator member 113, and ferrule 121, is electrically connected to jumper pin 125B. The connection between pin 123 and jumper pin 125B allows delivery of positive charge from electrode assembly 114 to electronic components outside of battery 106.

Fill port 181 (partially shown) allows introduction of liquid electrolyte 116 to electrode assembly 114. Electrolyte 116 creates an ionic path between anode 115 and cathode 119 of electrode assembly 114. Electrolyte 116 serves as a medium for migration of ions between anode 115 and cathode 119 during an electrochemical reaction with these electrodes.

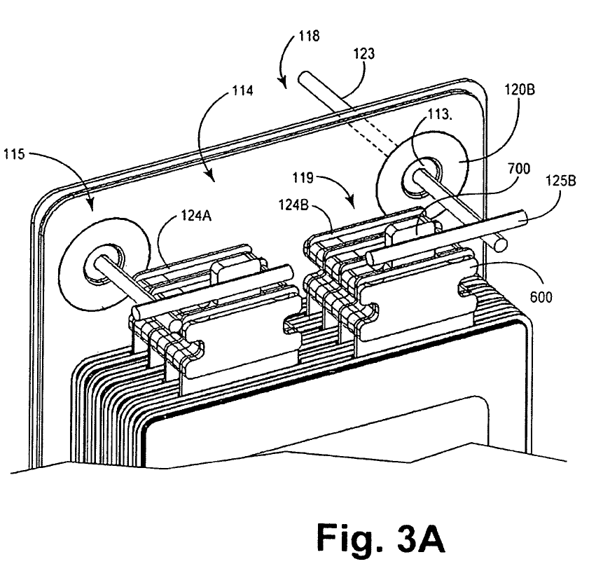

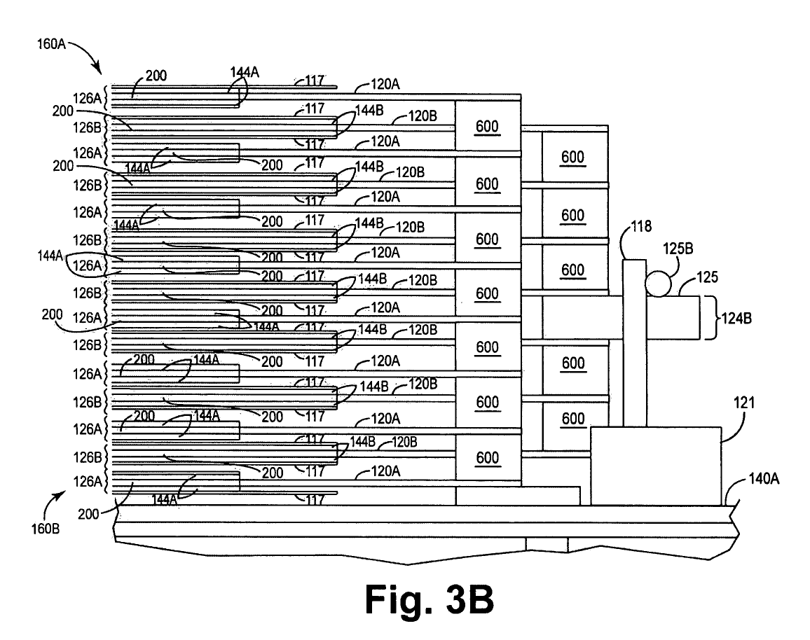

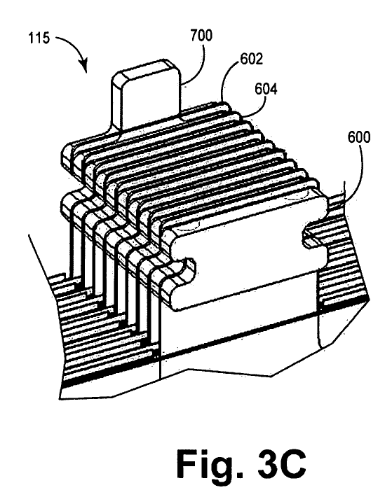

Referring to FIGS. 3A-3B, electrode assembly 114 is depicted as a stacked assembly. Anode 115 comprises a set of electrode plates 126A (i.e. anode electrode plates) with a set of tabs 124A that are conductively coupled via a conductive coupler 128A (also referred to as an anode collector). Conductive coupler 128A may be a weld or a separate coupling member. Optionally, conductive coupler 128A is connected to an anode interconnect jumper 125A, as shown in FIG. 2.

Each electrode plate 126A includes a current collector 200 or grid, a tab 120A extending therefrom, and electrode material 144A. Tab 120A comprises conductive material (e.g. copper, titanium, aluminum etc.). Electrode material 144A includes elements from Group IA, IIA or IIIB of the periodic table of elements (e.g. lithium, sodium, potassium, etc.), alloys thereof, intermetallic compounds (e.g. Li—Si, Li—B, Li—Si—B etc.), or an alkali metal (e.g. lithium, etc.) in metallic form. As shown in FIG. 3B, a separator 117 is coupled to electrode material 144A at the top and bottom 160A-B electrode plates 126A, respectively.

Cathode 119 is constructed in a similar manner as anode 115. Cathode 119 includes a set of electrode plates 126B (i.e. cathode electrode plates), a set of tabs 124B, and a conductive coupler 128B connecting set of tabs 124B. Conductive coupler 128B or cathode collector is connected to conductive member 129 and jumper pin 125B. Conductive member 129, shaped as a plate, comprises titanium, aluminum/titanium clad metal or other suitable materials. Jumper pin 125B is also connected to feed-through assembly 118, which allows cathode 119 to deliver positive charge to electronic components outside of battery 106. Separator 117 is coupled to each cathode electrode plate 126B.

Each cathode electrode plate 126B includes a current collector 200 or grid, electrode material 144B and a tab 120B extending therefrom. Tab 120B comprises conductive material (e.g. aluminum, etc.). Electrode material 144B or cathode material includes metal oxides (e.g. vanadium oxide, silver vanadium oxide (SVO), manganese dioxide etc.), carbon monofluoride and hybrids thereof (e.g., CFₓ+MnO₂), combination silver vanadium oxide (CSVO), lithium ion, other rechargeable chemistries, or other suitable compounds.

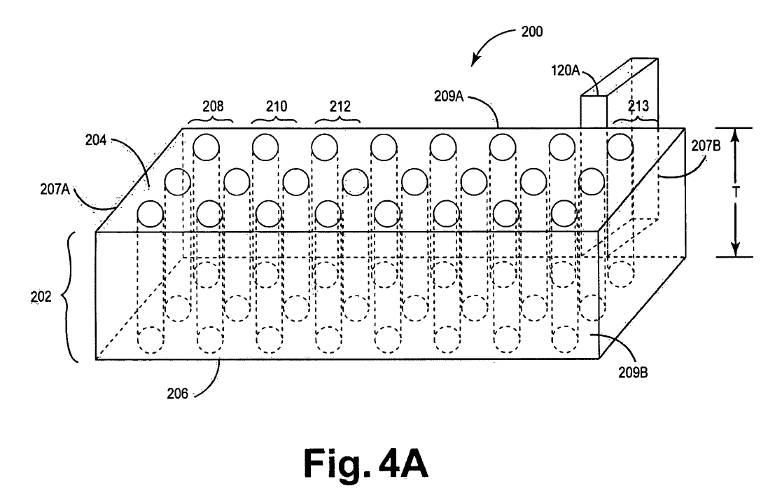

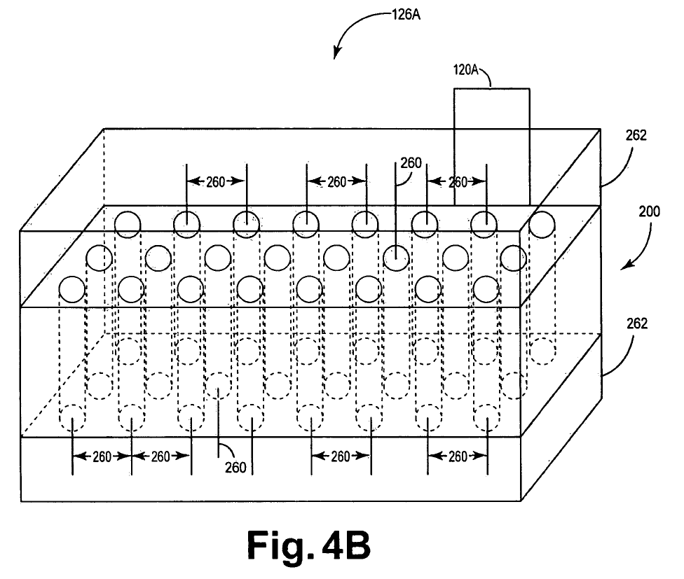

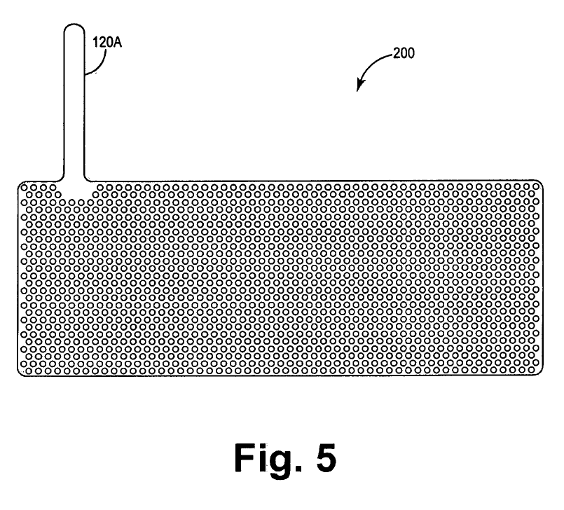

FIGS. 4A-4B and 5 depict details of current collector 200. Current collector 200 is a conductive layer 202 that includes sides 207A, 207B, 209A, 209B, a first surface 204 and a second surface 206 with a connector tab 120A protruding therefrom. A first, second, third, and N set of apertures 208, 210, 212, 213, respectively, extend from first surface 204 through second surface 206. N set of apertures are any whole number of apertures. Conductive layer 202 may comprise a variety of conductive materials. Current collectors 202 for cathode 119 and tab 120B may be, for example, titanium, aluminum, nickel or other suitable materials. For an anode 115, current collector 200 and tab 120A comprise nickel, titanium, copper an alloy thereof or other suitable conductive material.

Referring to FIG. 4B, apertures 208, 210, 212, 213 in current collector 200 allows electrode material 262 (i.e. electrode material 144A or electrode material 144B) to electrostatically interact to form bonds 260. Bonds 260 ensure that electrode material 262 does not delaminate from current collector 200.

One embodiment of the claimed invention relates to a spacer 600. Spacer 600 is placed between each tab (e.g. a first and a second tab 602, 604) of set of tabs 120A related to anode 115, as depicted in FIGS. 3A-C, 6A-6B. Spacer 600 ensures tabs 602, and 604 are substantially straight such that one spacer allows the first and the second tabs to be offset by about ≦0.05 inches and is not bent during a subassembly process to connect the set of tabs 124A, 124B for each electrode (i.e. anode or cathode). An offset tab can return to its original position when pressure is removed from the tab. A bent tab is physically deformed and does not spring back to its original position when pressure is removed from the tab. While single spacers 600 are depicted as being placed between two tabs, skilled artisans appreciate that more than one spacer 600 (e.g. two spacers, three spacers, four spacers etc.) may be placed between two tabs.

Spacers 600 typically comprise a conductive material. For electrode plates related to anode 115, titanium and alloys thereof or other suitable materials are used. For electrode plates related to cathode 119, titanium, nickel, aluminum, alloys thereof or other suitable materials are used.

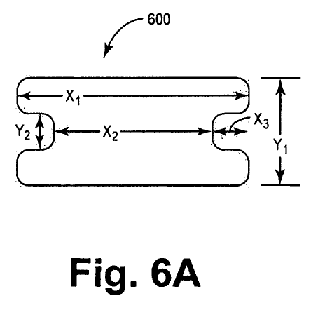

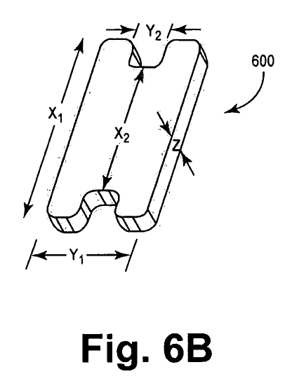

Spacers 600 may include a variety of shapes. Exemplary spacers include a substantially H-shaped spacer, substantially rectangular, circular, or include at least one triangular shape (e.g. a single triangle, a hexagon etc.). FIGS. 6A-6B are directed to a substantially H-shaped spacer 600. Spacer 600 is defined by first, second, third, and fourth lengths X1, X2, X3, Y1, Y2, respectively and thickness Z. Exemplary values for spacer 600 include X1=0.190 inches (in), X2=0.130 in, X3=0.030 in, Y1=0.090 in, Y2=0.30 in, Z=0.20 in. In one embodiment, spacers 600 may possess the same thickness Z. Alternatively, spacers 600 may have different thicknesses to achieve different design criteria. For example, a thicker electrode plate generally requires a thicker spacer. To illustrate, the thickness of a spacer may range from ten to sixty thousands of an inch. In an alternate embodiment, the thickness of a spacer is less than sixty thousands of an inch.

Other sizes or dimensions can be used to configure different shaped spacers 600. In one embodiment, spacer 600 is used between each tab (e.g. tab 120A) except where the tabs need to be connected to either case 140B or the pin. In this situation, spacer 700 is coupled between a tab 120A and to either case 140B or the pin.

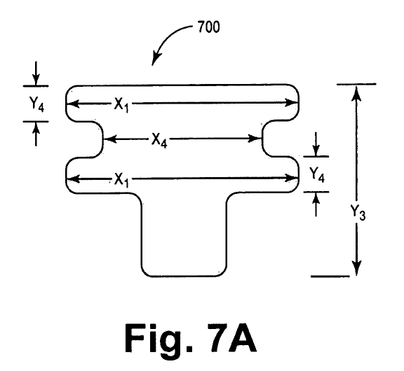

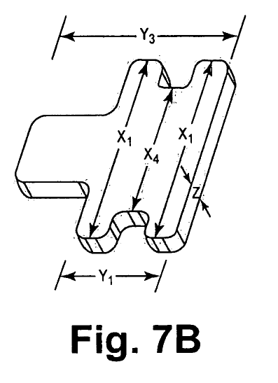

Another spacer 700 is depicted in FIGS. 7A-7B. Spacer 700 is substantially double T-shaped or “hammer head” shaped. Spacer 700 is defined by first length X1, fifth length X4, sixth length Y3 and thickness Z. In one embodiment, spacer 700 comprises spacer 600 with an additional tab 120A (also referred to as a “jumper” spacer). In yet another embodiment, spacer 700 is a single piece (not formed by a tab with an H-shaped spacer 600). With respect to Z, thinner spacers 600 (e.g. about 0.005 in etc.) may be used to finish the interconnect stack. Thinner spacers 600 at the end of the interconnect stack assist in obtaining an excellent weld. Thinner spacers also reduce overall interconnect height. Exemplary values for spacer 700 include X1=0.190 in, X4=0.120 in, Y3=0.160 in, Y4=0.030 in, and ′Z=0.20 in.

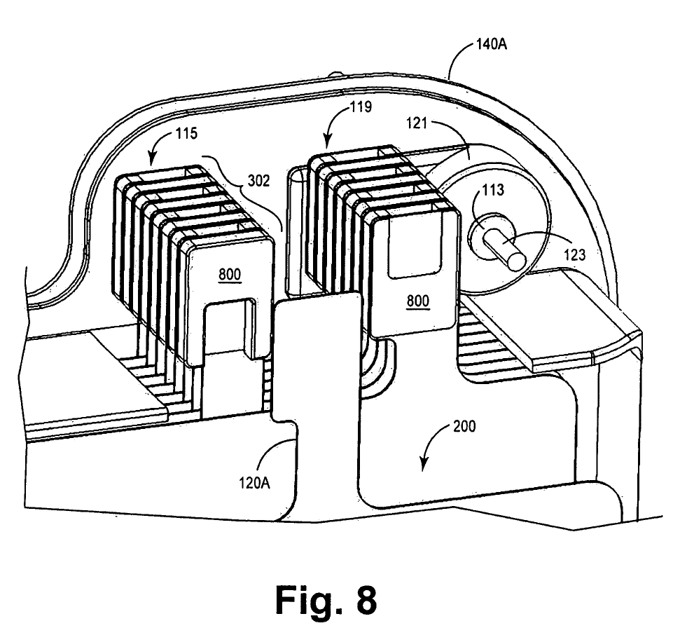

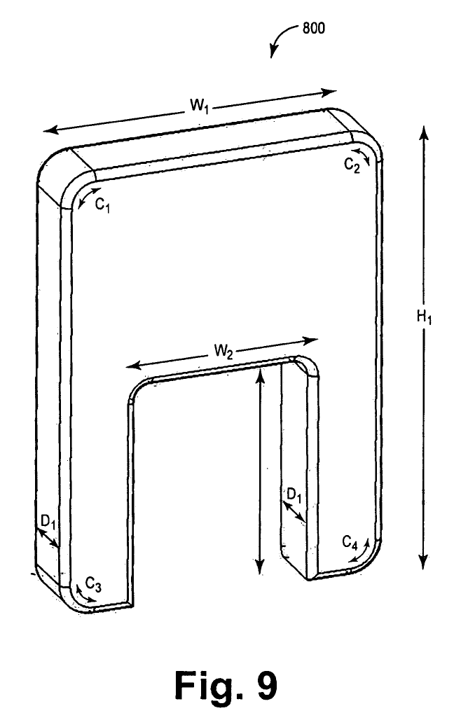

Referring to FIGS. 8-9, spacer 800 is substantially rectangular. An exemplary rectangular spacer 800 includes a length of about 0.14 in, a width of about 0.07 in, and a thickness of about 0.02 in. The corners c1, c2, c3, and c4 are rounded. In another embodiment, substantially circular spacer 500 includes a diameter that ranges from about 0.05 in to about 0.30. In another embodiment, spacer 800 can possess a triangular shape that includes first, second, and third lengths that range from about 0.05 in to about 0.30. Spacers 800 are positioned between tabs through, for example, a “pick and place” operation using a robot (not shown). Alternatively, spacers 800 can be manually inserted between tabs.

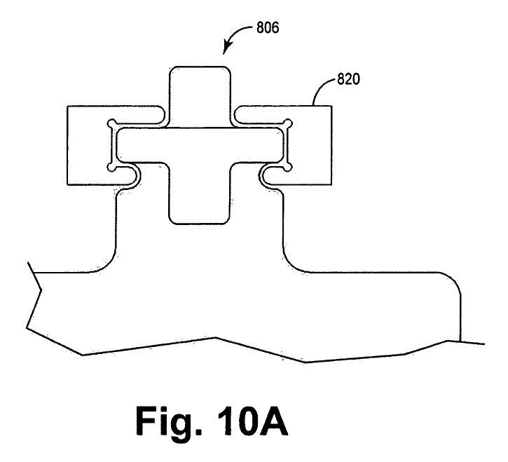

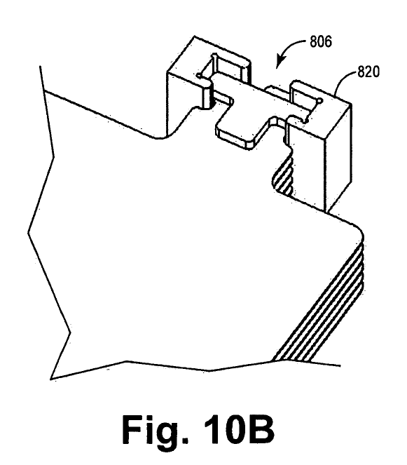

After spacers 800 are properly placed between set of tabs 806, spacers 800 and set of tabs 806 are positioned in a nest 820 of a stacking device, as shown in FIGS. 10A-10B. Set of tabs 806 and spacers 800 are then connected through a single laser welding operation that achieves a superior weld. Spacers 800 also prevent bending of tabs and enables automation. While the claimed invention has been described relative to a battery, it is understood that spacers could also be placed between tabs used in a capacitor.

The description of the invention is merely exemplary in nature and, thus, variations that do not depart from the gist of the invention are intended to be within the scope of the invention. Such variations are not to be regarded as a departure from the spirit and scope of the invention. For example, while several embodiments include specific dimensions, skilled artisans appreciate that these values will change depending, for example, on the shape of a particular element. Additionally, while the present invention seeks to avoid bents tabs, the tab may become bent during assembly operations, material properties and/or tab dimensions. Accordingly, one or more bent tabs may occur and are considered as an embodiment of the present invention in combination with at least one spacer between two or more tabs.

1. An electrode for a battery in an implantable medical device comprising:
a first electrode element with a first tab extending therefrom;
a second electrode element with a second tab extending therefrom; and
at least one spacer coupled to the first and second tabs, the at least one spacer disposed between the first and second tabs.

2. The electrode of claim 1 wherein the at least one spacer is conductive.

3. The electrode of claim 2 wherein the at least one spacer comprises one of titanium, nickel, aluminum, and alloys thereof.

4. The electrode of claim 1 wherein the at least one spacer eliminates the first and the second tabs from being bent.

5. The electrode of claim 1 wherein the at least one spacer allows the first and the second tabs to be offset compared to a planar surface.

6. The electrode of claim 5 wherein the at least one spacer allows the first and the second tabs to be offset by about ≦0.05 inches.

7. The electrode of claim 1 wherein the at least one spacer possesses one of a substantially rectangular shape, a substantially triangular shape, a substantially circular shape, a substantially T shape, and a substantially H shape.

8. A battery for an implantable medical device comprising:
an anode which includes a first anode electrode plate and a second anode electrode plate, the first and second anode electrode plates possess a first and second anode tab, respectively;
an anode spacer being coupled to the first anode tab and the second anode tab;
a cathode which includes a first cathode electrode plate and a second cathode electrode plate, the first and second cathode electrode plates possess a first and second cathode tab, respectively;
a cathode spacer being coupled to the first cathode tab and the second cathode tab; and
electrolyte over the anode and the cathode.

9. The battery of claim 8 wherein the anode spacer comprises titanium.

10. The battery of claim 8 wherein the cathode spacer comprises one of titanium, nickel, aluminum and alloys thereof.

11. The battery of claim 1 wherein the anode spacer possesses one of a substantially rectangular shape, a substantially triangular shape, a substantially circular shape, a substantially T shape, and a substantially H shape.

12. The battery of claim 1 wherein the cathode spacer possesses one of a substantially rectangular shape, a substantially triangular shape, a substantially circular shape, a substantially T shape, and a substantially H shape.

13. An electrode for a battery in an implantable medical device comprising:
a first electrode element with a first tab extending therefrom;
a second electrode element with a second tab extending therefrom; and
a spacer coupled to the first and second tabs.

12. The electrode of claim 13, wherein the spacer being disposed between the first and second tabs.

13. The electrode of claim 13, wherein the spacer being a block.

14. The electrode of claim 13, wherein the spacer being shaped as one of substantially rectangular, circular, square, pentagon, and a hexagon.

15. The electrode of claim 13, wherein the spacer being shaped as including at least one triangular shape.

16. The electrode of claim 13, wherein the spacer being shaped as including at least one substantially triangular shape.

17. The electrode of claim 13, wherein the spacer being shaped as one of a T-shape, a H-shape, and an L-shape, and a rectangle shape.

18. The electrode of claim 13, wherein the spacer includes at least one recessed region.

19. The electrode of claim 13, wherein the spacer element comprises a same conductive material as the first tab.

20. The electrode of claim 13, wherein the spacer comprises a different conductive material as the first tab.

21. The electrode of claim 13, wherein the spacer coupled to one of a case and a feedthrough pin.

22. An electrode for a battery in an implantable medical device comprising:
a first electrode element with a first tab extending therefrom;
a second electrode element with a second tab extending therefrom; and
a set of spacers coupled to the first and second tabs, the set of spacers disposed between the first and second tabs.

23. A battery in an implantable medical device comprising:
an anode which includes a first anode electrode plate and a second anode electrode plate, the first and second anode electrode plates possess a first and second anode tab, respectively;
an anode spacer being coupled to the first anode tab and the second anode tab;
a cathode which includes a first cathode electrode plate and a second cathode electrode plate, the first and second cathode electrode plates possess a first and second cathode tab, respectively;
a cathode spacer being coupled to the first cathode tab and the second cathode tab; and
electrolyte over the anode and the cathode.
